(19) United States
(12) Patent Application Publication
(10) Pub. No.: US 2017/0154550 A1
(43) Pub. Date: Jun. 1, 2017

(54) Tabletop Billboard Display Device

(71) Applicant: David Sauerwald, Pittsboro, NC (US)

(72) Inventor: David Sauerwald, Pittsboro, NC (US)

(21) Appl. No.: 14/953,158

(22) Filed: Nov. 27, 2015

(51) Int. Cl. G09F 7/00

(52) U.S. Cl. CPC G09F 7/00; G09F 2007/1804

(57) ABSTRACT

A placard display device suitable for tabletop or floor mounted displays is presented. The placard display device having one or more placard display elements is composed of a base, with one or more retaining structures for condiments, a vertical bar, and one or more placard retainers attached to the vertical bar. The placard retainers are manufactured of a material that is attractive to magnetic materials, and placards that are used with the display device are manufactured of magnetic materials. The placards may be printed with any advertising, informational, or other message the owner would like to present to patrons. Placards are placed in contact with the placard retainers and held in position through magnetic force attraction. The placards may be attached and removed multiple times with no loss of function.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

A restaurant experience may be enhanced by the service and advertising encountered at the table by patrons. Servers introduce themselves by name to patrons when they arrive at the table in an attempt to make the visit more relaxed and the service more personal. Additionally, advertising and special offers are displayed to patrons through the use of various placards, chalkboards, brochures, menus, and other materials placed at the table. Servers may use some of these materials to display the specials and additional advertising to patrons at the table. When a server is not at the table, patrons may review or handle the advertising materials to learn about the specials and deals available.

Advertising materials used at the table top, including such materials as specials lists and special menu items, must be durable. These items are handled multiple times each evening and thus benefit from being made of strong, tear-resist paper, plastic, and other print materials. However, print materials are not capable of being reprinted and once torn or worn out must be discarded. Additionally, professionally printed materials can be very expensive to create and a restaurant often must purchase bulk quantities of the printed advertising cards, brochures, menus or other items to make the purchase cost effective.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a front view of a placard display device consistent with certain embodiments of the present invention.

FIG. 2 is a side view of a placard display device consistent with certain embodiments of the present invention.

FIG. 3 is a connector view of a placard display device consistent with certain embodiments of the present invention.

FIG. 4 is a front view of a placard display device with one placard attached consistent with certain embodiments of the present invention.

FIG. 5 is a view of a multiple placard attachment to the placard display device consistent with certain embodiments of the present invention.

FIG. 6 is a view of a multiple orientation for the placard element attachment to the placard display device consistent with certain embodiments of the present invention.

FIG. 7 is a view of a multiple orientation for the multiple placard orientation for the placard display device consistent with certain embodiments of the present invention.

### DETAILED DESCRIPTION

While this invention is susceptible of embodiment in many different forms, there is shown in the drawings and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Reference throughout this document to “one embodiment,” “certain embodiments,” “an exemplary embodiment,” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

A placard display device is a table top to floor model sized communication assistance device. The placard display device has one or more placard retainer elements that are manufactured of any alloy or material, such as any number of steel or iron alloys for example, to which a magnetic material will adhere through magnetic attraction. The placard retainer elements also have a bottom retainer portion that permits a user to align a placard properly with the placard retainer such that a placard placed on the placard retainer is in alignment with the surface direction of the placard retainer. The placard retainer(s) are physically connected to a vertical bar at sufficient heights to be readily visible to patrons sitting at a table, or entering a retail establishment such as a restaurant. Additionally, the placard display device may have a base having one or more retention structures that may hold condiments, sauces, bowls, mints, ad gifts, or any other promotional or useful item the owner of the retail establishment may wish to provide to patrons while at a table. Retention structures may include recesses, railings attached at the perimeter of the base, vertical edges, or any other structure positioned to contain condiments or any other item provided by the owner of the retail establishment. The base may have a flat surface and perimeter shape that is rectangular, square, circular, triangular, or any other geometric shape that is of sufficient size to affix the vertical bar and onto which an owner may place a plurality of items such as condiments, sauces, bowls, mints, ad gifts or other items provided for use to the patron. In this embodiment, the base may have additional structural features for the acceptance and retention of items such as napkins or specialty promotional items created and presented as gifts, takeaway items, advertising items, promotional items, or any other item that may require a customized structural retention structure to which the item may be inserted.

The placards to be utilized with the placard display device are manufactured of any material that may be magnetized, although, in one embodiment, a plasticized or polymerized magnetic material is preferred. The surface of the placard that is placed in contact with the placard retainer may be blank with the surface of the placard that is presented to patrons when the placard is affixed to the placard retainer being printed. The printed surface may have advertising, menu, specialty items, instructions, or any other communication that the retail establishment owner may wish to share with patrons. The printing may be custom ordered by a retail establishment owner to create placards in specific sizes and with specific messages for the retail owner. The placards are manufactured of a durable magnetic material that may be affixed to and removed from the placard retainer numerous times before the placard is no longer usable. Placards may also be stacked back to front as they are attached to the placard retainer, the magnetic attractive force maintaining the placards in position as they are affixed to the placard display device.

The placard retainers are easily attached to the vertical bar of the placard display device through the use of a two-part attachment brace. The first part of the attachment brace is permanently attached to the side of the placard retainer that faces away from a patron when the unit is in use. The second portion of the attachment brace consists of one or more clamp portions. Each portion of the attachment brace has a middle section that is configured to be the same shape and size as the cross-section shape and size of the vertical bar. When the two portions of the attachment brace are placed around the vertical bar and secured in place with two or more attachment screws, the attachment brace holds the placard retainer in a vise-like grip and maintains the vertical position of the placard retainer on the vertical bar. The placard retainer may be repositioned on the vertical bar by releasing the attachment screws, moving the placard retainer to a new position, and retightening the attachment screws.

The placard retainer element may consist of a single placard retainer, a dual placard retainer in which two single placard retainer elements are affixed back-to-back in a 180 degree configuration, or in other configurations as required by a user. Multiple placard retainer elements may also be affixed to a single vertical bar, presenting a configurable number of placard retainers to which placards, and, thus, ads and messages, may be attached.

It should be understood that additional configurations of placard retainer elements may be created, such as a triple configuration where the placard retainer elements may be connected so as to form a triangle affixed to a vertical bar. Other geometric orientations may also be contemplated, as well as manners in which the placard retainer elements may be physically affixed to the vertical bar. Alternate geometric orientations may be created, such as, by way of example and not of limitation, connecting placard retainer elements so that they are not parallel but in an orientation that forms an angle between the proximate and distal ends of the placard retainer elements. Such orientations for the placard retainer elements are only limited by the size of the placard and the need for a flat surface to which one or more placards may be affixed.

To the accomplishment of the foregoing and related ends, the following description and annexed drawings set forth certain illustrative aspects and implementations. Other aspects, advantages, and novel features of the disclosure will become apparent from the following detailed description when considered in conjunction with the associated drawings.

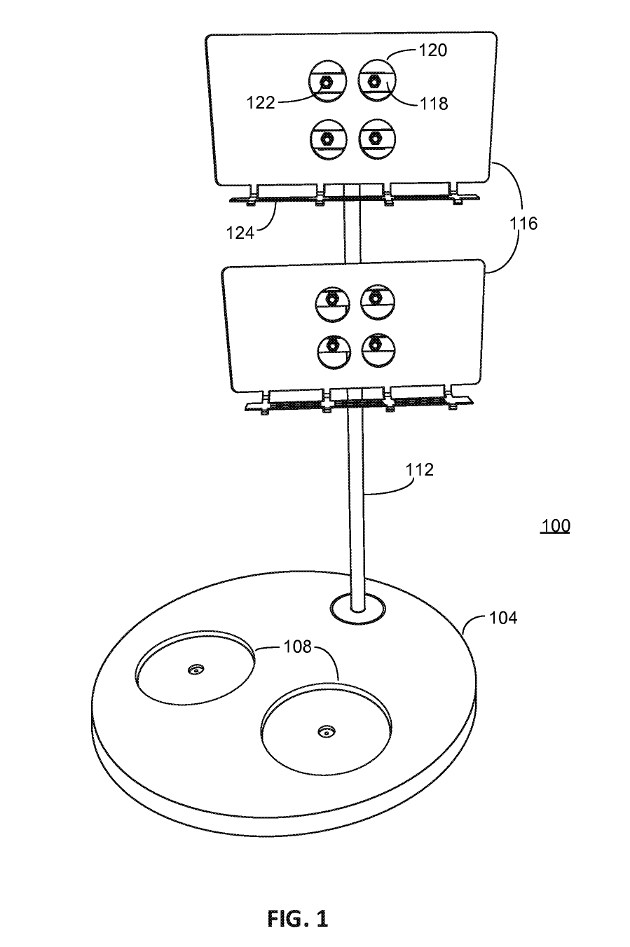

Turning now to FIG. 1, this diagram presents a front view of a placard display device consistent with certain embodiments of the present invention. In this embodiment, a placard display device 100 is of a proper size to fit on a table top typically found in a restaurant, bar, café, or any similar commercial establishment in which patrons are served food and beverages, presented with items for sale, or for which patrons may have a reason to remain at the table. The placard display device 100 may have a base 104, which is in a horizontal configuration such that the base 104 is in parallel orientation to a table top when placed thereon. The base 104 may have one or more retention structures 108 for the insertion and placement of condiments such as salt, pepper, sauces, pickled vegetables, toothpicks, or any other condiment or item a restaurant or retail patron may find useful and an owner of the restaurant or retail location may wish to provide to their patrons. In this embodiment, retention structures may include recesses, railings attached at the perimeter of the base, vertical edges, or any other structure positioned to contain condiments or any other item provided by the owner of the retail establishment. The base 104 may have a flat surface and perimeter shape that is rectangular, square, circular, triangular, or any other geometric shape that is of sufficient size to affix a vertical bar 112 and onto which an owner may place a plurality of items such as condiments, sauces, bowls, mints, ad gifts or other items provided for use to the patron.

In an embodiment, the base 104 may be configured such that the base may rotate in a circular manner around the centroid of the base 104. A gimbal, ball bearings, wheels or any other mechanism such as is known in the art may permit the rotation of the base 104 about the centroid of the base 104.

Inserted into the base 104 may be a vertical bar 112 that is oriented in a vertical direction perpendicular to the base 104. The vertical bar 112 may be secured to the base 104 through the use of glue, a threaded bolt with a screw, or any other means for securely affixing the vertical bar 112 into the base 104 so as to hold the vertical bar 112 in a perpendicular orientation to the base 104. In an alternative embodiment, the vertical bar 112 and the base 104 may be created as a single unit such as through the use of a flow molding process, through the use of a three dimensional printing process, or any other process that may create the base 104 and vertical bar 112 in the proper orientation to one another.

In this embodiment, one or more placard retainers 116 may be affixed to the vertical bar 112. Each placard retainer 116 is affixed through an attachment brace 118 that is affixed to the reverse side of each placard retainer 116. The attachment brace 118 is also configured to attach to the vertical bar 112 so as to keep each placard retainer 116 in a desired position on the vertical bar 112. Each placard retainer 116 is of the proper size to permit a placard (not shown) having a pre-defined size to be affixed to the placard retainer 116 in such a manner that the placard may be affixed and removed repeatedly, and reliably, from the placard retainer 116 without damage to the placard. Each placard retainer 116 is composed of a material that permits a magnetic placard to be attached and held to the placard retainer 116. In a non-limiting example, each placard retainer 116 is composed of an iron alloy to which a magnetic material is attracted and to which a magnetic material will remain affixed when placed in contact with the placard retainer 116. This example should not be considered limiting, however, as any material to which a magnetic material, such as a magnetic placard, may remain affixed through magnetic attraction may also be used to construct each placard retainer 116.

In this embodiment, each placard retainer 116 may have one or more holes 120 that penetrate through the entirety of the placard retainer 116. These holes 120 serve a dual purpose. When attaching or affixing a placard to the placard retainer 116, the holes 120 prevent air which may interfere with a secure attachment of a placard from being trapped between the placard and the surface of the placard retainer 116. The holes 120 may also be positioned so as to permit access to screws 122 that when tightened secure the attachment brace 118 to the vertical bar 112.

In this embodiment, each placard retainer 116 may also be configured with a horizontal rail 124. The horizontal rail 124 may be constructed of the same magnetic material as the placard retainer 116 and may be affixed at the bottom of the placard retainer 116 in a perpendicular orientation to the surface of the placard retainer 116. In this orientation, the horizontal rail 124 is properly positioned to provide guidance to users in the placement of one or more placards on the placard retainer 116, and to server as a bottom edge retaining structure for all placards affixed to the placard retainer 116.

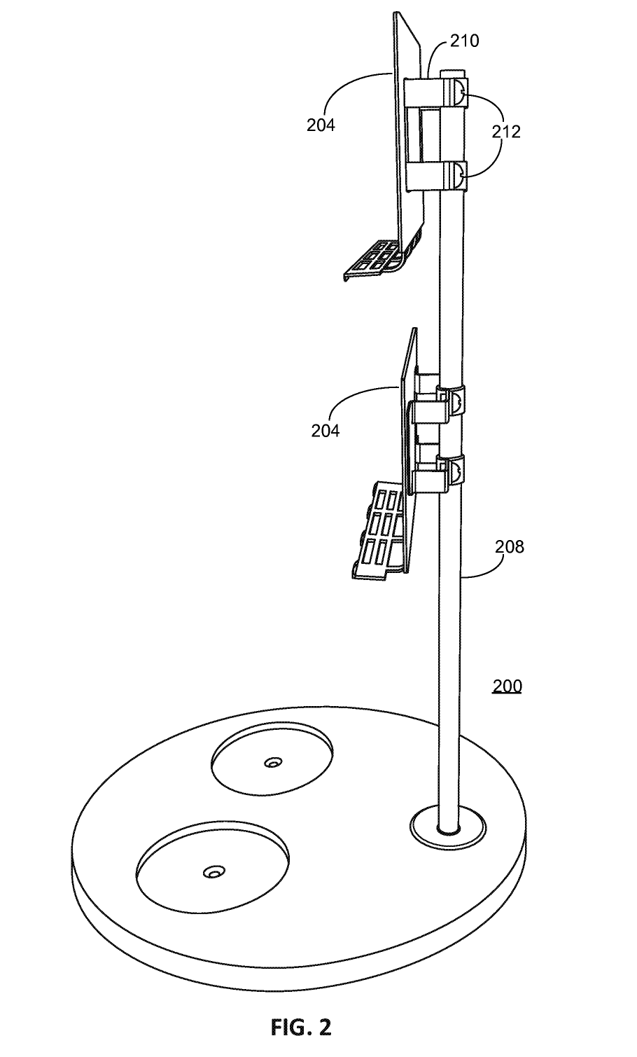

Turning now to FIG. 2, this diagram presents a side view of a placard display device consistent with certain embodiments of the present invention. In an embodiment, the placard display device 200 may have one or more placard retainers 204 affixed to a vertical bar 208 at vertical positions along the vertical bar 208 suitable to permit the attachment of placards of various sizes. In this non-limiting example, the placard display device 200 has two placard retainers 204 placed at vertical positions on the vertical bar 208 that permit one or more 3″ by 5″ placards to be placed on each placard retainer 204. The placards are constructed of a material that is magnetic, and the placard retainers 204 are manufactured of an alloy or other material to which a magnetic material will attach and remain attached through the magnetic force associated with each placard. It should be understood that the placards are not limited to a particular size and that the placard retainers 204 may be removed and their position on the vertical bar 208 modified to accommodate different sizes of placards. Additionally, the number of placard retainers 204 that are affixed to the vertical bar 208 may be changed to accommodate different sizes of placards.

In this exemplary embodiment, it can be seen that the placard retainers 204 are affixed to the vertical bar 204 through the use of an attachment brace 210. The attachment brace 210 is permanently attached to the placard retainer 204. A central portion of the attachment brace 210 is manufactured in the same shape and size as the physical cross section of the vertical bar 208. This shape permits the attachment brace 210 to conform to the shape and size of the vertical bar 208, permitting the attachment brace 210 to be affixed to the vertical bar 208 through the use of two or more screws 212. Tightening the screws 212, in combination with the conforming shape of the attachment brace, provides sufficient clamping force to retain the placard retainer 204 in the physical position on the vertical bar 208 desired by a user of the placard display device 200.

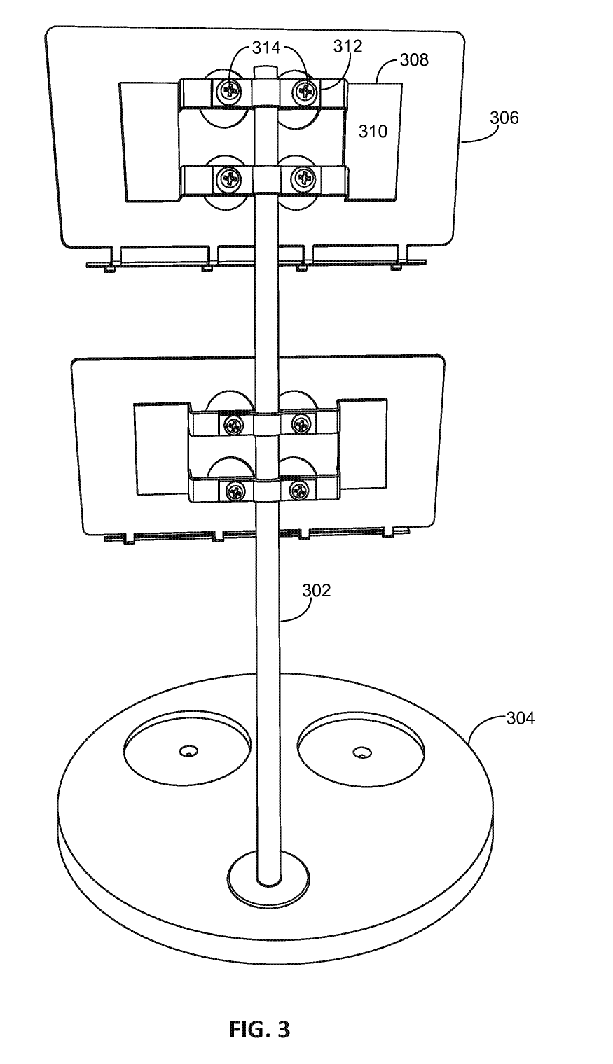

Turning now to FIG. 3, this diagram presents a detailed view of the attachment brace for a placard display device consistent with certain embodiments of the present invention. In this exemplary embodiment, a vertical bar 302 is affixed in a perpendicular orientation to the device base 304. The vertical bar 302 may have one or more placard retainers 306 each having an attachment brace 308 for affixing each placard retainer 306 to the vertical bar 302.

In this embodiment, the attachment brace 308 may be composed of a backing portion 310 that is permanently affixed to one side of the placard retainer 306, and one or more clamp portions 312 that are removably attached to the attachment brace 308 through the connection of two or more screws 314. The backing portion 310 and the clamp portion 312 may each be manufactured with a central portion that conforms to the shape and size of the vertical bar 302. The vertical bar 302 may be manufactured in any shape, such as cylindrical, square, triangular or any other shape that may be considered most convenient or useful for affixing the one or more placard retainers 306 to the vertical bar 302. Regardless of the shape and size of the vertical bar 302, the central portion of the backing portion 310 and the clamp portion 312 of the attachment brace 308 are each formed to the same shape and cross-section size of the vertical bar 302 to form a clamp attachment to the vertical bar 302. To attach the placard retainer 306 the backing portion 310 may be positioned in contact with the vertical bar 302, the clamp portion 312 is positioned on the opposing side of the vertical bar 302 with the screw holes in alignment to permit the insertion of the screws 314 into the screw holes. Tightening the screws 314 may create a vice-like grip for the attachment brace 308 that secures the placard retainer 306 in the position desired.

In this embodiment, to reposition the placard retainer 306, the user simply loosens the screws 314 to release the vice-like grip, repositions the placard retainer 306 to an alternative position on the vertical bar 302, and retightens the screws 314 to hold the placard retainer in the updated position.

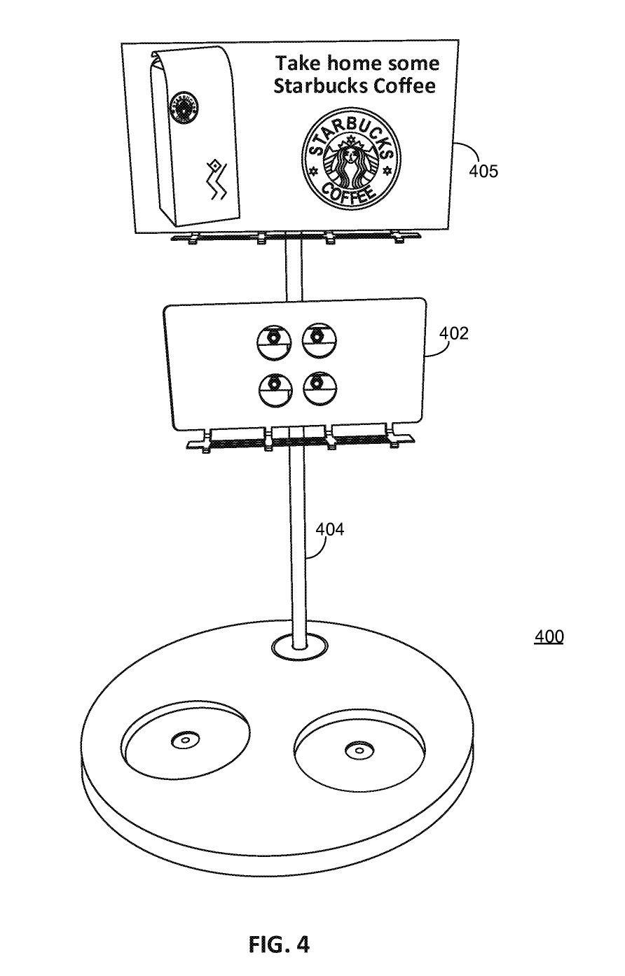

Turning now to FIG. 4, this diagram presents a front view of a placard display device with one placard attached consistent with certain embodiments of the present invention. In an embodiment, with the one or more placard retainers 402 positioned and securely attached to the vertical bar 404, a user or patron may place placards 405 in contact with the placard retainer 402 to have them securely held in position on the placard display device 400. Each placard retainer 402 is manufactured of an alloy or other material to which magnets will attach and remain in place through magnetic force interaction. Each placard 405 may be manufactured of a material that may be induced to become magnetic. Each placard 405 may then be retained in place on the placard display device 400 as they come into contact with the placard retainer 402.

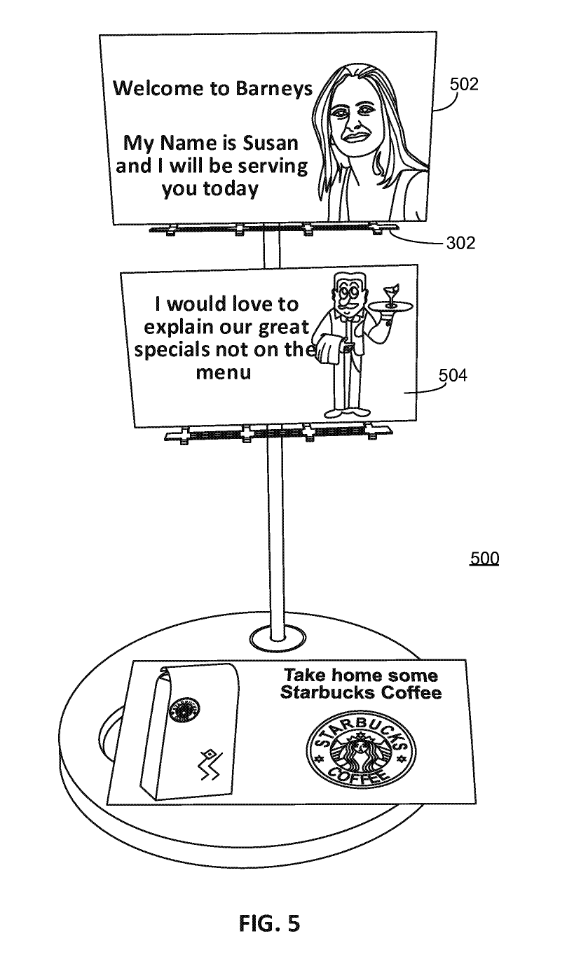

Turning now to FIG. 5, this diagram presents a view of a multiple placard attachment to the placard display device consistent with certain embodiments of the present invention. In an embodiment, placards 502 may be manufactured in any size that a user of the system finds convenient or useful for the purposes for which the user intends to use the system. In a non-limiting example, the placard display device 500 may be designed for use as a tabletop display for presenting advertising, menus, specials, informational messages, photos, graphics, multimedia compositions, or any other printed communication to patrons of a retail or commercial space. However, the table top display model should not be considered limiting, as the placard display device 500 may be manufactured in various sizes and configurations. Such configurations may include, but are not limited to, a free standing version that is suitable for placement on the floor of a retail or commercial space and of sufficient height to present information from a placard attached to a placard retainer attached to the vertical bar at patron eye-level.

The placards 502 may have a magnetic side (not shown) and a printed side 504. The magnetic, non-printed side may be placed in contact with the placard retainer surface (not shown), using a horizontal rail 506 to assist with placard alignment. Once in contact, the placard 502 is retained by the magnetic force interaction between the placard 502 and the placard retainer material. Each placard 502 may be removed and replaced with a different placard, or placards may be stacked one on top of another with the entire stack remaining on the placard retainer through magnetic attraction.

The printed side 504 of the placard 502 may be imprinted with any diagram, photo, picture, message, advertisement, or any other communication the owner or manager of the commercial space wishes to convey to patrons. Messages, information or communications may be customized for each retail or commercial space. The information may be communicated to the producer of the placards and the placards custom printed onto the magnetic material of which the placards are manufactured. These custom placards may then be shipped to the entity that ordered the custom placards in a timely manner.

By way of example, and not of limitation, a restaurant owner may order a placard for each of the wait staff that presents the name and a photo of the wait staff. Each table that is assigned to the individual wait staff member may have a placard 502 attached to the placard retainer of the placard display device 500. Each patron seated at the table during the wait staff member's shift will have the name and photo of the wait staff assigned to assist them. As wait staff members change shifts, the placard 502 of the newly assigned wait staff person will replace the placard 502 of the previous wait staff member assigned to the table. In an additional non-limiting example, the daily specials, newly advertised items, advertising messages, or other special messages may also be printed onto placards. These message placards 502 may then be placed on the placard display device 500 to present the patron with the desired information in a durable and reusable manner.

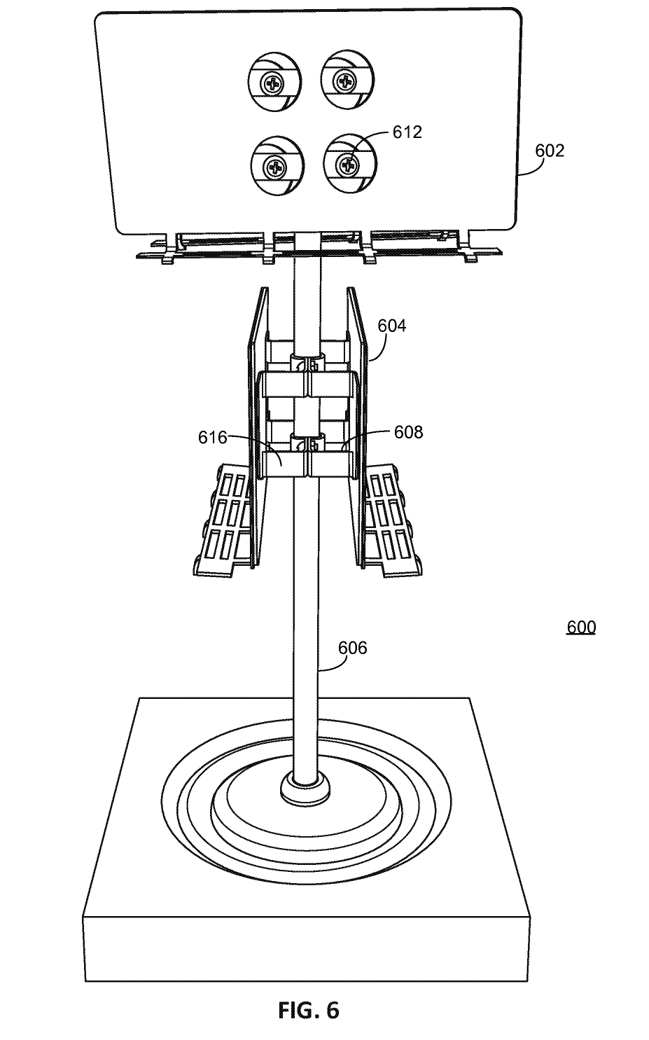

Turning now to FIG. 6, this diagram presents a view of a multiple orientation for the placard element attachment to the placard display device consistent with certain embodiments of the present invention. In this exemplary embodiment, the placard display device 600 may have a plurality of placard retainers 602 that are connected in complementary orientations and configurations so as to provide the ability to present numerous messages, advertisements, amusements, or other communications to patrons. In this exemplary embodiment, the placard display device 600 presents a configuration where two placard retainers 602, each of which is configured to receive placards, are connected back-to-back, in parallel, as a dual placard element 604. The dual placard element 604 is also attached to the vertical bar 606 through the use of an attachment brace 608, where the attachment braces associated with each placard retainer are connected together as they are attached to the vertical bar 606. This permits two placard to be presented in a 180 degree orientation from one another, allowing patrons on each side of a table to be presented with the same or different communications. In addition, more than one dual placard element 604 may be affixed to the vertical bar 606 to provide additional message space, as well as additional aesthetic arrangements.

In this exemplary embodiment, each dual placard element 604 may be affixed to the vertical bar 606 through the use of two or more screws 612. As described previously, the screws 612 may be accessed through one or more holes 614 drilled through the flat surface of each placard retainer 602 that forms a portion of the dual placard element 604. In this configuration, the attachment braces 616 affixed to each of the placard elements 602 are placed in contact, as well as in contact with the vertical bar 606, and the screws 612 are inserted into holes drilled for that purpose. Tightening the screws 612 attaches the two placard retainers 602 together and affixes the dual placard element created to the vertical bar 606 at the same time.

It should be understood that additional configurations of placard retainer elements may be created, such as a triple configuration where the placard retainer elements may be connected so as to form a triangle affixed to a vertical bar. Other geometric orientations may also be contemplated, as well as manners in which the placard retainer elements may be affixed to the vertical bar. Alternate geometric orientations may be created, such as, by way of example and not of limitation, connecting placard retainer elements so that they are not parallel but in an orientation that forms an angle between the proximate and distal ends of the placard retainer elements. Such orientations for the placard retainer elements are only limited by the size of the placard and the need for a flat surface to which one or more placards may be affixed.

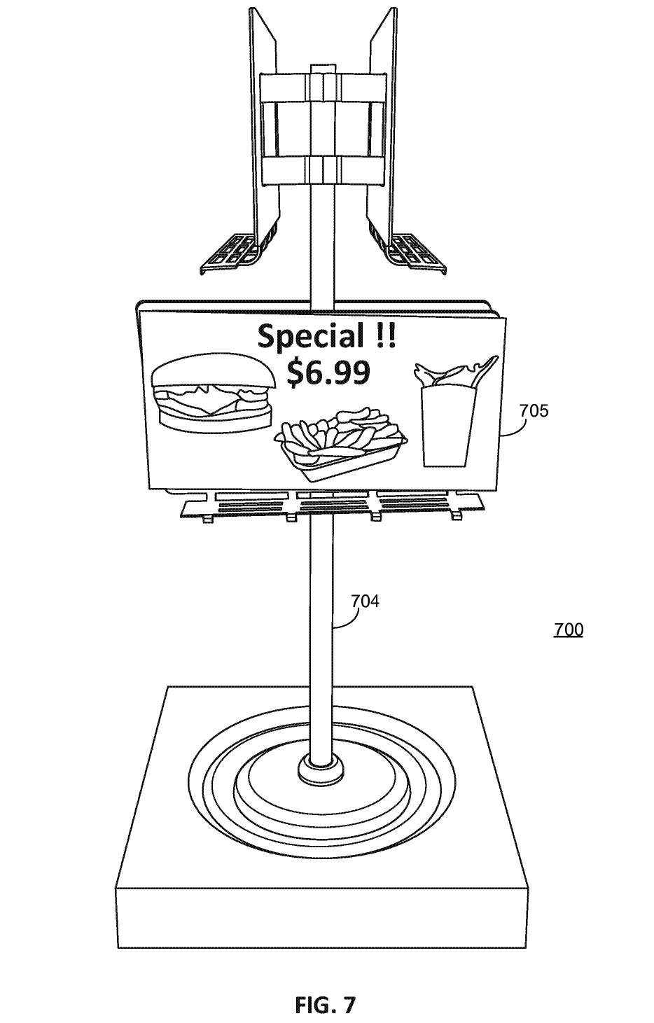

Turning now to FIG. 7, this diagram presents a view of a multiple orientation for the multiple placard attachment to the placard display device consistent with certain embodiments of the present invention. In this non-limiting example, the placard display device 700 may have multiple dual placard elements 702 affixed to the vertical bar 704. Each dual placard element 702 presents a 180 separation between the faces of each placard retainer of which the dual placard element 702 is comprised. In this example, two dual placard elements 702 are attached to the vertical bar 704 in a perpendicular orientation in relation to the vertical bar 704. This number of dual placard elements 702 and orientation, permits patrons occupying all four seats at a square or rectangular table to be presented with the same, or different, message. Each placard 705 may have a message, ad, or other communication on the face of the placard 705 that is presented to the patron seated in front of that portion of the placard display device 700. Additionally, the vertical bar 704 of the placard display device 700 may be configured to rotate in a circular manner, permitting all patrons at the table to be presented with the communication on the face of each placard as the vertical bar 704 is rotated.

While certain illustrative embodiments have been described, it is evident that many alternatives, modifications, permutations, and variations will become apparent to those skilled in the art in light of the foregoing description.

What is claimed is:

1. A placard display apparatus, comprising:
a base, to which a vertical bar is affixed;
one or more placard retainer elements removably attached to the vertical bar;
one or more placards for placement on the placard retainer element(s);
where the placard retainer is manufactured of a magnetic attractive material, each placard is manufactured of a magnetic material; and
each placard is retained in place when placed in contact with the placard retainer element through the magnetic attractive force between the magnetic material of the placard and the magnetic attractive material of the placard retainer.

2. The apparatus of claim 1, where each placard retainer may be manufactured of ferrous alloys, or any other material to which a magnet would attach and remain in place through magnetic force.

3. The apparatus of claim 1, where each placard is manufactured of magnetic materials, such as flexible magnetic materials, iron alloys, steel alloys, or any other material that may be magnetized.

4. The apparatus of claim 1, where each placard may be printed on one side with advertising, menus, specials, informational messages, photos, graphics, multimedia compositions, or any other printed material.

5. The apparatus of claim 1, further comprising placard retainers connected back-to-back as they are affixed to the vertical bar.

6. The apparatus of claim 1, where the placard retainers are removably affixed to the vertical bar by an attachment brace.

7. The apparatus of claim 6, where the attachment brace is comprised of two portions that form a clamp around the vertical bar when attached and hold any placard retainer associated with the attachment brace to the vertical bar.

8. The apparatus of claim 1, where the placard display apparatus is of sufficient size to be placed on a table top of a table that would be typically found in a retail establishment.

9. The apparatus of claim 1, where the placard display apparatus is of sufficient size to the placed on the floor and present a placard at eye-level to patrons of a retail establishment when the placard is affixed to a placard retainer.

10. The apparatus of claim 1, where the base of the placard display apparatus is of sufficient size to place condiments, sauces, bowls, mints, ad gifts, or any other promotional or useful item to be given to, or used by, a patron.

11. The apparatus of claim 1, where the base of the placard display rotates about the centroid of the base.

12. The apparatus of claim 1, where the base has one or more retention structures such as recesses, railings attached at the perimeter of the base, vertical edges, or any other structure positioned to contain condiments or any other item to be provided for patrons of a retail establishment.
